(19) United States
(12) Patent Application Publication
(10) Pub. No.: US 2026/0053318 A1
(43) Pub. Date: Feb. 26, 2026

(54) Particle Collection Device for Collecting Particles, Filter Cleaning Unit for Such a Particle Collection Device, and Power Tool with Such a Particle Collection Device

(71) Applicant: Robert Bosch GmbH, Stuttgart (DE)

(72) Inventors: Daniel Barth, Leinfelden-Echterdingen (DE); Florian Esenwein, Leinfelden-Echterdingen (DE)

(21) Appl. No.: 19/305,529

(22) Filed: Aug. 20, 2025

(30) Foreign Application Priority Data
Aug. 21, 2024 (DE) 10 2024 207 932.4

(51) Int. Cl. A47L 9/20; A47L 7/00; A47L 9/12; A47L 9/14; B23Q 11/00; B24B 55/10

(52) U.S. Cl. CPC A47L 9/20; A47L 7/0095; A47L 9/127; A47L 9/1445; B23Q 11/0046; B24B 55/102

(57) ABSTRACT

A particle collection device, in particular a dust box, for a power tool, in particular for an eccentric or orbital sander, includes at least one collection unit for collecting particles, at least one filter cleaning unit, and at least one impulse element. The collection unit includes at least one collection container, in particular a collection receptacle, with at least one filter unit. The filter unit is arranged in the collection container for filtering particles from a fluid flowing through the collection container. The at least one filter cleaning unit is arranged on the collection container, which has at least one longitudinal axis about which the filter cleaning unit is rotatably mounted relative to the collection container and/or the filter unit. The at least one impulse element, in particular an impact extension, is configured to transmit an impulse to individual folds of a pleated filter of the filter unit.

This application claims priority under 35 U.S.C. § 119 to patent application no. DE 10 2024 207 932.4, filed on Aug. 21, 2024 in Germany, the disclosure of which is incorporated herein by reference in its entirety.

### BACKGROUND

A filter unit for a particle collection device that can be detachably attached to a hand-held power tool has already been proposed.

### SUMMARY

A particle collection device for a power tool, comprising at least one collection unit for collecting particles, which has at least one collection container, at least one filter unit for filtering particles from a fluid flowing through the collection container, and at least one filter cleaning unit arranged on the collection container, which has at least one longitudinal axis about which the filter cleaning unit is rotatably mounted relative to the collection container and/or the filter unit, and at least one impulse element which is designed to transmit an impulse to the filter unit.

The disclosure relates to a particle collection device, in particular a dust box, for a power tool, in particular for an eccentric or orbital sander, with at least one collection unit for collecting particles, which has at least one collection container, in particular a collection receptacle, with at least one filter unit, in particular arranged in the collection container, for filtering particles from a fluid flowing through the collection container and with at least one filter cleaning unit arranged on the collection container, which has at least one longitudinal axis about which the filter cleaning unit is rotatably mounted relative to the collection container and/or the filter unit, and at least one impulse element, in particular an impact extension, which is designed to transmit an impulse to the filter unit, in particular to individual folds of a pleated filter of the filter unit.

The disclosure proposes that the filter cleaning unit comprises at least one fluid guiding element, in particular a hollow body, preferably a hollow shaft, which is at least largely surrounded by the filter unit which extends at least substantially over the entire longitudinal extent of the filter unit and is provided for discharging the fluid, in particular the particle-filtered fluid, through an outlet opening from the collection container.

The embodiment of the particle collection device according to the disclosure can advantageously achieve efficient removal of a particle-cleaned fluid. Advantageously, a large filter area of the filter unit can be achieved, as the filter cleaning unit can be arranged in the filter unit to save space, whereby a fluid flow through the filter unit can be advantageously maintained. Furthermore, the particle-filtered fluid can advantageously be discharged directly on the clean air side of the filter unit in a flow-efficient manner. A particularly long service life of the filter unit can be achieved. In addition, particles, such as sanding dust, can be prevented from adhering to the filter unit. It is particularly advantageous to counteract clogging of the filter unit. Furthermore, particularly efficient filtering of particles from a fluid flow can be provided. It is possible to achieve a particularly high level of operating convenience and particularly efficient use of a power tool.

The particle collection device is preferably intended to collect particles that are removed from a workpiece by a machining tool arranged on a tool holder of the power tool. The particles may be, in particular, dust, abrasion, chips or the like, which are produced by machining a material, for example wood, metal, plastic or the like, with the power tool, in particular with a machining tool arranged on a tool holder of the tool holder, such as an abrasive, a cutting disc, a grinding wheel, a grinding belt, a sawing tool, a milling tool or the like. Preferably, the particle collection device can be detachably attached to the power tool, in particular to an suction nozzle of the power tool. Preferably, the particle collection device comprises a connection interface which is provided for a positive and/or non-positive connection with the power tool, in particular with the suction nozzle. “Provided” is understood in particular as meaning specifically adapted, specifically programmed, specifically designed and/or specifically equipped. The fact that an object is intended for a specific function should be understood in particular to mean that the object fulfills and/or executes this specific function in at least one application and/or operating mode.

The collection receptacle is preferably designed as a dimensionally stable collection container, for example as a dust container or as a dust box, for collecting particles. The collection receptacle may have a circular cylindrical shape. It would also be possible for the collection receptacle to have an ellipsoidal or polygonal shape. Alternatively, the collection receptacle could also be designed as a flexible collection container, for example as a dust bag, a dust sack or the like. The collection receptacle is preferably made of a plastic, for example of transparent polypropylene or the like. However, it is also conceivable that the collection container is made of a metal or a combination of metal and one or more plastics. Alternatively, the collection container is made of textile, fleece, glass fiber, quartz fiber, a combination of these, or another material that appears suitable to a person skilled in the art.

Preferably, at least one closure element, in particular a closure cap, is arranged on the collection container of the collection unit, which closure element delimits at least one outlet opening of the collection container. Furthermore, the collection unit preferably comprises a further closure element, in particular a further closure cap, which is arranged on a side of the collection unit facing the power tool when the particle collection device, in particular the collection unit, is arranged on the power tool, and which delimits at least one inlet opening of the collection container. The connection interface of the particle collection device is preferably arranged on the further closure element, in particular the further closure cap, and in particular is formed in one piece with the closure element. Preferably, the closure element and/or the further closure element can be fastened to the collection container by means of a screw connection. However, it would also be conceivable for the closure element and/or the further closure element to be attachable to the collection container by means of a plug connector or another frictional and/or interlocking connection that appears sensible to a person skilled in the art, such as a bayonet connection, a clamp connection, or the like. Preferably, the closure element and the further closure element have the same form of connection to the collection container. However, it is also conceivable that the closure element and the further closure element have different forms of connection to the collection container.

The filter unit is preferably designed to separate particles, impurities and/or substances from a fluid flow, in particular an air flow. Preferably, the filter unit has a filter medium, in particular a filter element, preferably a pleated filter, which is, for example, hollow-cylindrical, cylindrical, cuboid or similar. The filter unit is preferably designed as a pleated filter unit, particularly preferably as a lamella filter unit. The filter element preferably has a circular cross-sectional shape, especially when viewed in a plane extending perpendicular to the longitudinal axis. Preferably, the outer edges of the folds of the pleated filter are arranged in a circular pattern with respect to the plane perpendicular to the longitudinal axis of the filter unit. Preferably, the filter unit has a support element at least one axial end to stabilize the pleated filter against deformation. The filter medium can, for example, be made of textiles, paper, non-woven fabric, glass fiber, a metal mesh, synthetic membranes, a combination of these or any other material that would appear useful to a person skilled in the art.

The filter cleaning unit is preferably intended to exert a mechanical effect on the filter unit, by means of which particles adhering to the filter medium, in particular the pleated filter, can be loosened. Preferably, the filter cleaning unit acts directly on the filter unit, in particular the pleated filter. The mechanical action of the filter cleaning unit on the filter unit can be, for example, tapping, beating, brushing, rubbing or similar. The longitudinal axis of the filter cleaning unit preferably runs parallel to, in particular coaxially with, the longitudinal axis of the filter unit. Preferably, the longitudinal axis of the filter cleaning unit runs perpendicular to a plane surrounding the outlet opening of the collection container. Preferably, the longitudinal axis runs parallel to a main extension plane of the collection container. The “main extension plane” of an element or a component shall be understood in particular to mean a plane which is parallel to the largest lateral surface of the smallest imaginary cuboid which just completely encloses the element or component and which passes in particular through the center of the cuboid. Preferably, the filter cleaning unit is essentially completely, in particular completely, surrounded by the filter unit. It is also conceivable that the filter cleaning unit is arranged outside the filter unit. Preferably, the filter cleaning unit is mounted so that it can rotate about the longitudinal axis relative to the filter unit and/or the collection container. It is conceivable that the filter cleaning unit can be rotated manually by a user. It would also be possible for the filter cleaning unit to be rotated by an additional actuating element, such as an electric motor. Preferably, the filter cleaning unit strikes the folds of the pleated filter with the impulse element, in particular in a circumferential direction of the filter unit extending in a plane perpendicular to the longitudinal axis of the filter cleaning unit. Preferably, an impact against the folds of the pleated filter can also be radial, in particular perpendicular to the longitudinal axis of the filter cleaning unit. It would also be conceivable for the filter cleaning unit to act mechanically on the filter unit in a direction parallel to the longitudinal axis of the filter unit.

The impulse element is preferably designed as a radial and/or circumferential directional impact extension. Preferably, the impulse element has a trapezoidal shape, with the base of the trapezoid being arranged on the fluid guiding element. It would also be conceivable for the impulse element to have a rectangular, triangular or round shape. Preferably, a maximum length of a base of the impulse element is more than 2.5%, particularly preferably more than 5% and particularly preferably more than 10% of a maximum axial length of the filter unit extending parallel to the longitudinal axis. Alternatively, the maximum axial length of the base of the impulse element can also be less than 2.5% of the maximum axial length of the filter unit extending parallel to the longitudinal axis. In a radial direction, in particular perpendicular to the longitudinal axis, the impulse element extends preferably over a distance of more than 10%, preferably more than 15% and particularly preferably more than 20% and less than 50% of a maximum fold depth into a space between two folds of the pleated filter. It would also be conceivable for the impulse element to extend along the radial direction over a distance of less than 10% of the maximum pleat depth into the space between two folds of the pleated filter. Preferably, the impulse element has an elastic bending behavior about an axis parallel to the longitudinal axis of the filter cleaning unit and the filter unit. When the filter cleaning unit is rotated, the impulse element is preferably pre-tensioned at one pleat edge of the pleated filter and preferably strikes against the next pleat in the direction of rotation of the filter cleaning unit when the filter cleaning unit is rotated further. It would also be conceivable for the impulse element to be pretensioned at one pleat edge of the pleated filter in such a way that it strikes against several pleat edges, not just the next pleat edge.

The fluid guiding element is preferably designed to discharge the particle-cleaned fluid from the collection container through an outlet opening. The fluid guiding element is preferably designed as a hollow shaft, the inner cross-section of which is preferably largely hollow. Alternatively, the fluid guiding element can be designed as a solid body that has one or more internal channels for discharging the particle-filtered fluid. The inner ducts can have a straight or curved course. Preferably, the fluid guiding element is fluidically connected to the outlet opening of the collection container. Preferably, the fluid guiding element is surrounded by the filter cleaning unit for at least more than 50% of the total circumferential extent of the filter unit along a circumferential direction of the collecting container extending in a plane perpendicular to the longitudinal axis of the filter cleaning unit. The fluid guiding element is preferably made of a plastic, for example glass fiber reinforced polyamide or the like. However, it is also conceivable that the fluid guiding element could be made of a metal or a combination of materials.

It is further proposed that the fluid guiding element has at least one inlet opening, in particular several inlet openings, for the fluid into a cavity and/or into an inner channel of the fluid guiding element, which is arranged in an outer wall of the fluid guiding element extending at least substantially parallel to the longitudinal axis of the filter cleaning unit. The inlet openings are preferably circular in shape. Alternatively, it would be conceivable for the inlet openings to have a shape other than circular. The fluid guiding element preferably has two inlet openings, which are arranged diametrically on the fluid guiding element. Furthermore, the fluid guiding element can have additional, axially offset inlet openings. Preferably, the two inlet openings of the fluid guiding element, in particular those arranged diametrically relative to each other, are arranged offset relative to each other by an angle of 180° along a circumferential direction of the fluid guiding element extending in a plane perpendicular to the longitudinal axis of the fluid guiding element. However, it would also be conceivable that the inlet openings are arranged offset relative to each other along the circumferential direction of the fluid guiding element, preferably by an angle of 90°, particularly preferably by an angle of 60° or by another angle that appears reasonable to the person skilled in the art. Advantageously, efficient removal of the particle-filtered fluid can be provided through an inner channel of the fluid guiding element. A flow resistance for the fluid flowing through the particle collection device is reduced in a particularly advantageous way.

Furthermore, it is proposed that the impulse element is arranged eccentrically offset to the longitudinal axis of the filter cleaning unit on a fluid guiding element, in particular on the fluid guiding element. It is conceivable that the particle collecting device for solving the problem according to the disclosure is designed in an alternative embodiment independently of the fluid guiding element, which is designed in particular as a hollow body, preferably as a hollow shaft, and is provided for discharging the fluid, in particular particle-filtered fluid, through the outlet opening from the collecting container. Preferably, the particle collection device comprises, in the alternative embodiment, in particular in the embodiment independent of the fluid guiding element, which is designed in particular as a hollow body, preferably as a hollow shaft, and is provided for discharging the fluid, in particular the particle-filtered fluid, through the outlet opening from the collection receptacle, at least the collection unit for collecting particles, which has at least the collection receptacle, in particular the collection container, with at least the filter unit, in particular arranged in the collection receptacle, for filtering particles from the fluid flowing through the collection receptacle, and with at least the filter cleaning unit arranged on the collection container, which has at least one longitudinal axis about which the filter cleaning unit is rotatably mounted relative to the collection container and/or the filter unit, as well as at least the impulse element, in particular the impact extension, which is intended to transmit an impulse to the filter unit, in particular to individual folds of the pleated filter of the filter unit, wherein the impulse element is arranged eccentrically offset relative to the longitudinal axis of the filter cleaning unit on a fluid guiding element, in particular on the fluid guiding element, which may be designed, for example, free of inner channels for discharging the fluid, in particular the particle-filtered fluid. Preferably, the impulse element is arranged eccentrically offset to the longitudinal axis of the fluid guiding element by a maximum of the length of the radius of the fluid guiding element. Preferably, the impulse element is arranged eccentrically offset to the longitudinal axis of the fluid guiding element by a maximum of 50%, particularly preferably by a maximum of 20% of the radius of the fluid guiding element. Such an arrangement advantageously results in a preferred bending direction of the impulse element and a preferred direction of rotation for actuating the filter cleaning unit. Advantageously, such an embodiment provides a flexible arrangement, as the impulse element can be long and therefore flexible. This has the particular advantage of minimizing the risk of damage to the pleated filter. In addition, an impulse transmitted by the impulse element to the folds of the pleated filter can be large, which advantageously enables high cleaning efficiency of the filter element.

It is further proposed that the fluid guiding element has at least one inlet opening, in particular multiple inlet openings, for the fluid into a cavity, in particular the aforementioned cavity, and/or into an internal channel, in particular the aforementioned inner channel, of the fluid guiding element, which is arranged in a region facing away from the outlet opening in an outer wall of the fluid guiding element extending at least substantially parallel to the longitudinal axis of the filter cleaning unit. The area of the fluid guiding element facing away from the outlet opening preferably extends from the end of the fluid guiding element axially facing away from the outlet opening in the direction of the outlet opening over a maximum of 40% of a maximum axial length of the fluid guiding element extending parallel to the longitudinal axis. Particularly preferably, the area of the fluid guiding element facing away from the outlet opening extends from the end of the fluid guiding element axially facing away from the outlet opening in the direction of the outlet opening over a maximum of 30%, particularly preferably over a maximum of 20% of a maximum axial length of the fluid guiding element extending parallel to the longitudinal axis. Preferably, all inlet openings have an analog embodiment, in particular a circular shape. Alternatively, it is also conceivable that all or individual inlet openings have a shape other than circular. Furthermore, with such an embodiment, a fluid flow can be improved in such a way that the entire filter surface of the filter unit can be utilized for filtering particles from the fluid flow.

It is further proposed that the impulse element is arranged on an inner wall of the fluid guiding element, in particular on the inner channel of the fluid guiding element, and extends through a fluid guiding element recess of the fluid guiding element, in particular a fluid guiding element outer wall opening which is bounded by an outer wall of the fluid guiding element, wherein the impulse element extends across an outer surface of the fluid guiding element, preferably along a direction running transversely, in particular perpendicularly, to the longitudinal axis of the filter cleaning unit. Preferably, the fluid guiding element recess, viewed in a plane running parallel to the longitudinal axis of the fluid guiding element, has a surface area that is at least 200% larger than a cross-sectional area of the impulse element lying parallel to the longitudinal axis of the fluid guiding element. Particularly preferably, the surface extension of the fluid guiding element recess, viewed in the plane running parallel to the longitudinal axis of the fluid guiding element, is at least 150%, preferably at least 100%, larger than the cross-sectional area of the impulse element lying parallel to the longitudinal axis of the fluid guiding element. Preferably, the fluid guiding element recess has a larger area than an area of the cross-section of the impulse element that extends at a radial position of the impulse element in which it extends through the outer wall of the fluid guiding element. Preferably, the fluid guiding element recess limits bending of the impulse element. Such an embodiment can protect the impulse element from damage caused by excessive bending. In addition, particle-filtered fluid can flow into the fluid guiding element through the fluid guiding element recesses and be efficiently discharged from the collection container. Advantageously, a fluid flow with particularly low flow resistance can be provided.

Furthermore, it is proposed that the filter cleaning unit comprises at least one further impulse element offset along the longitudinal axis relative to the impulse element, which is arranged on one, in particular the inner channel of the fluid guiding element, preferably the inner wall of the fluid guiding element mentioned above, and which extends through a, in particular further, fluid guiding element recess of the fluid guiding element, in particular a further fluid guiding element outer wall opening, which is bounded by the outer wall of the fluid guiding element, wherein the further impulse element extends beyond the outer surface of the fluid guiding element, preferably along a direction running transversely, in particular perpendicularly, to the longitudinal axis of the filter cleaning unit. Preferably, the impulse element and the further impulse element, as well as the respective fluid guiding element recess and the respective further fluid guiding element recess, are arranged axially along the longitudinal axis at a distance from one another on the fluid guiding element. However, it would also be conceivable that the impulse element and the further impulse element are arranged axially such that the fluid guiding element recess for the impulse element and the further fluid guiding element recess for the further impulse element are adjacent to each other. Such an arrangement of the impulse element, the fluid guiding element recess, the further impulse element and the further fluid guiding element recess can further improve the removal of the particle-filtered air. Furthermore, the cleaning of the filter unit from particles can be improved.

It is further proposed that the fluid guiding element recess and the further fluid guiding element recess are arranged offset to one another, in particular offset by an angle of 90° to one another, in a circumferential direction of the fluid guiding element, in particular in the plane extending perpendicular to the longitudinal axis. However, an offset between the fluid guiding element recess and the further fluid guiding element recess along the circumferential direction by an angle other than 90° would also be conceivable. Such an arrangement of the fluid guiding element recess and the further fluid guiding element recess can advantageously achieve a discharge of the particle-filtered fluid.

It is further proposed that the filter cleaning unit comprises at least two impulse elements, which are each arranged on one, in particular on the previously mentioned, inner wall of the fluid guiding element and each have a main extension axis, wherein the main extension axes of the impulse elements, in particular in an unloaded state, extend at least substantially parallel to each other or at an angle to each other. A “main extension axis” of an element or a unit is to be understood in particular as an axis which runs parallel to a longest edge of a smallest geometric cuboid which just completely encloses the element or the unit. Preferably, a main direction of extension of the impulse element, starting from the side of the impulse element with which the impulse element is attached to the inner wall of the fluid guiding element, is directed parallel to the main extension axis of the impulse element towards the free-standing end of the impulse element. Preferably, the main directions of extension of the two impulse elements run in opposite directions. Preferably, the main directions of extension of the impulse elements extend from the inner wall of the fluid guiding element transversely through the fluid guiding element and preferably extend through the fluid guiding element recess beyond the outer wall of the fluid guiding element. Alternatively, when arranged on the inner wall of the fluid guiding element, the fluid guiding elements can extend over the outer surface of the fluid guiding element without passing through the fluid guiding element. The manufacture of the fluid guiding element with the impulse elements can be simplified and provided at low cost. Furthermore, particle-filtered fluid can be discharged more efficiently. An efficient fluid flow can be advantageously achieved.

In addition, it is proposed that the impulse element comprises a main extension axis, in particular the aforementioned axis of extension, which forms an angle deviating from 90° with an outer surface of the fluid guiding element, in particular running at least substantially parallel to the longitudinal axis of the filter cleaning unit. Preferably, the main extension axis of the impulse element forms an angle of less than 90° with the outer surface of the fluid guiding element in an unloaded state of the impulse element. In an unloaded state, the impulse element preferably forms an angle of between 45° and 90° with the outer surface of the fluid guiding element. However, it would also be conceivable for the impulse element to form an angle of less than 45° with the outer surface of the fluid guiding element in an unloaded state. Such an arrangement advantageously results in a preferred bending direction of the impulse element and a preferred direction of rotation of the filter cleaning unit. Advantageously, such an embodiment provides a flexible arrangement, as the impulse element can be made long and flexible. This has the particular advantage of minimizing the risk of damage to the pleated filter. In addition, a high impulse transmitted by the impulse element to the folds of the pleated filter can be made possible, which can advantageously enable a high efficiency of cleaning the filter element.

Furthermore, it is proposed that the collecting unit has at least one closure element, in particular the previously mentioned closure element, in particular the closure cap, which delimits at least one outlet opening, in particular the previously mentioned outlet opening, of the collecting container, and that the fluid guiding element has at least one locking element, in particular at least partially delimiting an inner channel, preferably the previously mentioned inner channel, of the fluid element, for locking with the closure element. It is conceivable that the particle collecting device for solving the problem according to the disclosure is designed in an alternative embodiment independently of the fluid guiding element, which is designed in particular as a hollow body, preferably as a hollow shaft, and is provided for discharging the fluid, in particular particle-filtered fluid, through the outlet opening from the collecting container. Preferably, the particle collection device comprises, in the alternative embodiment, in particular in the embodiment independent of the fluid guiding element, which is designed in particular as a hollow body, preferably as a hollow shaft, and is provided for discharging the fluid, in particular the particle-filtered fluid, through the outlet opening from the collection receptacle, at least the collection unit for collecting particles, which has at least the collection receptacle, in particular the collection container, with at least the filter unit, in particular arranged in the collection receptacle, for filtering particles from the fluid flowing through the collection receptacle, and with at least the filter cleaning unit arranged on the collection container, which has at least one longitudinal axis about which the filter cleaning unit is rotatably mounted relative to the collection container and/or the filter unit, as well as at least the impulse element, in particular the impact extension, which is intended to transmit an impulse to the filter unit, in particular to individual folds of the pleated filter of the filter unit, wherein the collection unit has at least one, in particular the closure element already mentioned above, in particular the closure cap, which delimits at least one, in particular the outlet opening of the collection container already mentioned above, and the fluid guiding element has at least one, in particular one, preferably the previously mentioned, locking element which at least partially delimits an inner channel of the fluid element for locking with the closure element. Preferably, the locking element is designed to latch with the closure element and to securely hold the fluid guiding element in the collection container and protect it from slipping out. The locking element is preferably designed as a spring locking element. Preferably, the spring locking element is designed as a rectangular section of the fluid guiding element that is free-standing on three sides, has a main direction of extension parallel to the longitudinal axis of the fluid guiding element and has a locking lug or a locking hook at its free-standing end. The locking element and the fluid guiding element are preferably formed in one piece. However, it is also conceivable that a locking mechanism could be provided by a spring-loaded locking bolt, a ball locking bolt, a locking pin or similar. Such an embodiment can be advantageously used to provide safe installation of the filter cleaning unit. The advantage of such an embodiment is that axial play can be kept to a minimum, thus avoiding vibrations during operation. In addition, particle-cleaned fluid can advantageously flow into the fluid guiding element through the recess between the spring element and the fluid guiding element.

It is also proposed that the receiving container has an outlet opening which has a cross-sectional shape, in particular deviating from a circular cross-section, preferably having at least one extension which limits a slit-like indentation of the outlet opening, which is intended to enable the insertion of a fluid guiding element, in particular the fluid guiding element, together with the impulse element extending beyond an outer surface of the fluid guiding element, into the collecting container. It is conceivable that the particle collecting device for solving the problem according to the disclosure is designed in an alternative embodiment independently of the fluid guiding element, which is designed in particular as a hollow body, preferably as a hollow shaft, and is provided for discharging the fluid, in particular particle-filtered fluid, through the outlet opening from the collecting container. Preferably, the particle collection device comprises, in the alternative embodiment, in particular in the embodiment independent of the fluid guiding element, which is designed in particular as a hollow body, preferably as a hollow shaft, and is provided for discharging the fluid, in particular the particle-filtered fluid, through the outlet opening from the collection receptacle, at least the collection unit for collecting particles, which has at least the collection receptacle, in particular the collection container, with at least the filter unit, in particular arranged in the collection receptacle, for filtering particles from the fluid flowing through the collection receptacle, and with at least the filter cleaning unit arranged on the collection container, which has at least one longitudinal axis about which the filter cleaning unit is rotatably mounted relative to the collection container and/or the filter unit, as well as at least the impulse element, in particular the impact extension, which is intended to transmit an impulse to the filter unit, in particular to individual folds of the pleated filter of the filter unit, wherein the collection container has the outlet opening, which has a cross-sectional shape, in particular deviating from a circular cross-section, preferably having at least one extension delimiting a slit-like indentation of the outlet opening, which is intended to enable the insertion of a fluid guiding element, in particular the fluid guiding element, together with the impulse element extending beyond an outer surface of the fluid guiding element, into the collection container. The outlet opening is preferably designed to allow the fluid guiding element with the impulse element extending over an outer surface of the fluid guiding element to be introduced into the collecting container without bending the impulse element. In a preferred embodiment, the outlet opening is arranged in a closure element of the collection container, for example a closure cap. Preferably, the cross-sectional shape of the outlet opening is intended to provide a key-lock fit with the fluid guiding element. Preferably, the extension delimiting a slit-like indentation of the outlet opening is arranged between two adjacent folds of the lamellar filter at the outlet opening when viewed in the axial direction. Alternatively, it would be conceivable for the outlet opening to also have further slit-like indentations in the outlet opening that delimit the outlet opening or extensions of a different design. As a result, the fluid guiding element with the impulse element can be inserted into the collection container advantageously easily, for example without bending the impulse element. Furthermore, it is particularly advantageous to insert the fluid guiding element into the collection container such that the impulse element is positioned between two adjacent folds of the lamellar filter. It is advantageous to prevent damage to the filter unit when installing the fluid guiding element.

In addition, it is proposed that the particle collecting device has at least one securing unit which is provided to counteract a loosening of a connection of the collecting container and a closure element, in particular a closure cap, of the collecting unit, on which at least one actuating element of the filter cleaning unit is arranged, which is provided for rotating the impulse element together with a fluid guiding element, in particular the fluid guiding element, about the longitudinal axis of the filter cleaning unit. It is conceivable that the particle collecting device for solving the problem according to the disclosure is designed in an alternative embodiment independently of the fluid guiding element, which is designed in particular as a hollow body, preferably as a hollow shaft, and is provided for discharging the fluid, in particular particle-filtered fluid, through the outlet opening from the collecting container. Preferably, the particle collection device comprises, in the alternative embodiment, in particular in the embodiment independent of the fluid guiding element, which is designed in particular as a hollow body, preferably as a hollow shaft, and is provided for discharging the fluid, in particular the particle-filtered fluid, through the outlet opening from the collection receptacle, at least the collection unit for collecting particles, which has at least the collection receptacle, in particular the collection container, with at least the filter unit, in particular arranged in the collection receptacle, for filtering particles from the fluid flowing through the collection receptacle, and with at least the filter cleaning unit arranged on the collection container, which has at least one longitudinal axis about which the filter cleaning unit is rotatably mounted relative to the collection container and/or the filter unit, as well as at least the impulse element, in particular the impact extension, which is intended to transmit an impulse to the filter unit, in particular to individual folds of the pleated filter of the filter unit, wherein the particle collection device has at least one securing unit which is designed to prevent the connection between the collection container and a closure element, in particular a closure cap, of the collection unit, on which at least one actuating element of the filter cleaning unit is arranged, which is designed to cause the impulse element to rotate together with a fluid guiding element, in particular the fluid guiding element, which is arranged around the longitudinal axis of the filter cleaning unit, from being released. fluid guiding element about the longitudinal axis of the filter cleaning unit. The securing unit is preferably designed as an axially elastic locking means, for example as a snap-in knobs, which latches with a complementary locking geometry arranged on the closure element. Preferably, the collecting container has two, for example diametrically arranged, snap-in knobs. It would also be conceivable for the collection container to have more than two snap-in knobs, which are arranged at one end of the collection container facing the closure cap. It is particularly preferred that the snap-in knobs face the closure element in the axial direction. However, it would also be possible for the snap-in knobs to extend in a radial direction, for example on the outside of the collection container in a direction radially away from the longitudinal axis of the collection container. However, it is also conceivable that the locking element is designed as a locking rail, a locking hole, a locking pin or similar. Such an embodiment can advantageously counteract accidental detachment of the closure element from the collection receptacle. A high level of user comfort can be achieved in a particularly advantageous way.

In addition, the disclosure is based on a filter cleaning unit for a particle collection device, in particular for the particle collection device according to the disclosure. As a result, the filter unit of the particle collection device can be easily cleaned of particles that have become stuck. Efficient filtration and a long service life of the filter unit can be provided as an advantage. Furthermore, existing particle collection devices can be retrofitted with the filter cleaning unit according to the disclosure at low cost and with little effort. A high level of sustainability can be achieved.

Furthermore, the disclosure is based on a power tool, preferably a hand-held power tool, in particular an eccentric or orbital sander, with at least one particle collection device, in particular with a particle collection device according to the disclosure. The power tool is preferably designed as a hand-held power tool. The power tool is preferably designed as a hand-held orbital or eccentric sander. It is also conceivable that the power tool has a different embodiment which appears sensible to a person skilled in the art, such as a drill, a drill and/or hammer machine, a sawing machine, a planing machine, a milling machine, an angle grinder, a garden tool, a multifunctional power tool, or the like. In particular, the power tool has a blower for removing particles. Preferably, the material removed from a workpiece machined by the power tool can be removed by an air flow generated, for example, by a fan impeller, in particular a fan impeller for cooling a motor of the power tool. Alternatively, the power tool may have a pump or suction unit driven by the motor of the power tool to remove the material removal. A blower driven by a separate motor, a separately driven pump or similar would also be conceivable.

The particle collection device according to the disclosure, the filter cleaning unit according to the disclosure and/or the power tool according to the disclosure should not be limited to the application and embodiment described above. In particular, the particle collection device according to the disclosure, the filter cleaning unit according to the disclosure and/or the power tool according to the disclosure may have a number of individual elements, components and units other than a number specified herein in order to fulfill a mode of operation described herein. Additionally, regarding the ranges of values indicated in this disclosure, values lying within the limits specified hereinabove are also provided to be considered as disclosed and usable as desired.

### BRIEF DESCRIPTION OF THE DRAWINGS

Further advantages follow from the description of the drawings below. An exemplary embodiment of the disclosure is shown in the drawing. The drawing, the description, and the claims contain numerous features in combination. A person skilled in the art will appropriately also consider the features individually and combine them into additional advantageous combinations.

The figures show:

FIG. 1 a power tool with a particle collecting device according to the disclosure in a schematic illustration,

FIG. 2 the particle collection device according to the disclosure in a schematic sectional view with a sectional plane parallel to a longitudinal axis of a filter unit,

FIG. 3 a collection receptacle, a closure element and a filter cleaning unit of the particle collection device according to the disclosure in a schematic exploded view,

FIG. 4 the filter cleaning unit with impulse elements, inlet openings, locking elements and an actuating element for the particle collection device according to the disclosure in a schematic illustration,

FIG. 5 a fluid guiding element of the filter cleaning unit in a schematic sectional view with a sectional plane perpendicular to a longitudinal axis of the fluid guiding element,

FIG. 6 the closure element of the particle collection device according to the disclosure, with an outlet opening,

FIG. 7 a filter unit for the particle collection device according to the disclosure in a schematic illustration,

FIG. 8 a support element of the filter unit for the particle collection device according to the disclosure, and

FIG. 9 a cross-sectional plane, parallel to a longitudinal axis of a filter unit, of a support element for a filter unit of the particle collection device according to the disclosure.

### DETAILED DESCRIPTION

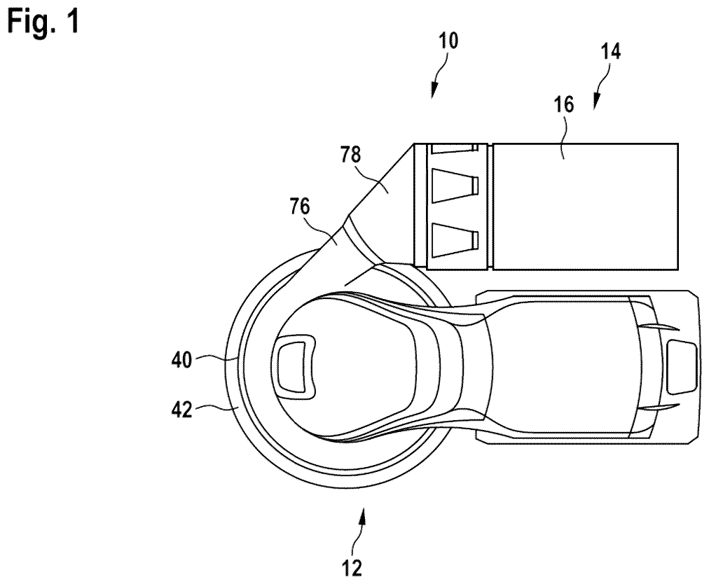

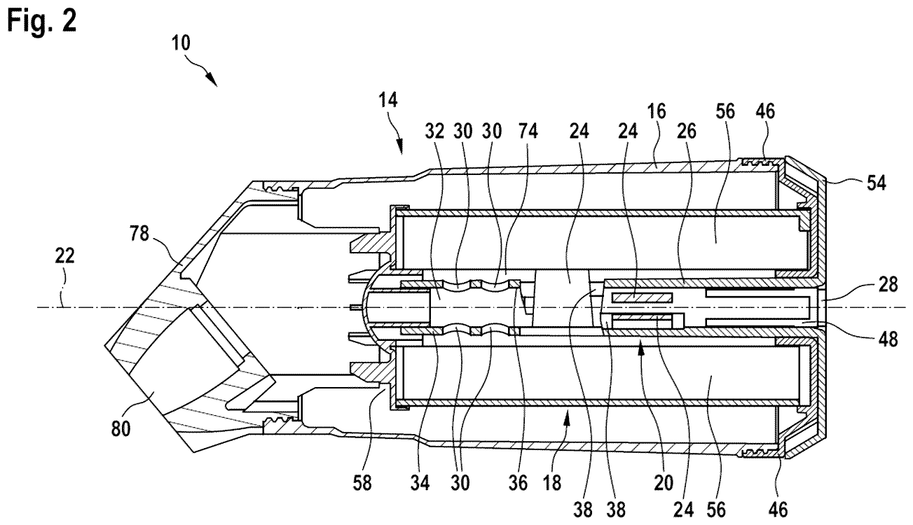

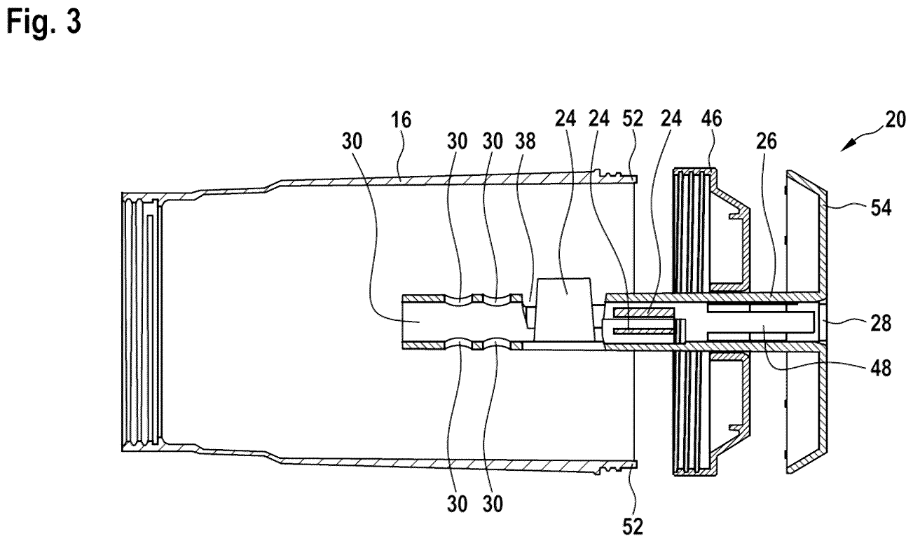

FIG. 1 shows a power tool 12 with a particle collection device 10. The power tool 12 is configured as a hand-held power tool. The power tool 12 is designed as an electric eccentric sander, in particular as a battery-powered eccentric sander. Alternatively, the power tool 12 could be designed as a fuel-powered eccentric or orbital sander, as a compressed air-powered eccentric or orbital sander, as a cut-off grinder, as a belt sander, as a drill, as a hand-held circular saw or the like.

The power tool 12 has a tool holder 40. A machining tool 42, in particular a grinding wheel, is arranged on the tool holder 40. The tool holder 40 is formed by a support plate. The tool holder 40 is formed, for example, by a circular support plate with a hook-and-loop surface. The machining tool 42 arranged on the tool holder 40 of the power tool 12 is intended to remove particles, in particular dust, from a workpiece during operation. Alternatively, however, it is also conceivable, in particular depending on the embodiment of the power tool 12, that the machining tool is designed as a cutting disc, a grinding belt, a milling tool, a saw blade or the like.

The power tool 12 comprises an suction nozzle 76. The suction nozzle is arranged on a housing of the power tool 12. The particle collection device 10 is provided for detachable connection to the suction nozzle 76.

The particle collection device 10 comprises a collection unit 14 for collecting the particles removed by the machining tool 42. The collection unit 14 comprises a collection container 16. The collection container 16 is configured as a collection receptacle. The collection receptacle is essentially cylindrical in shape. However, a polygonal shape of the collection receptacle is also conceivable. The collection receptacle is formed from a plastic, in particular a transparent plastic.

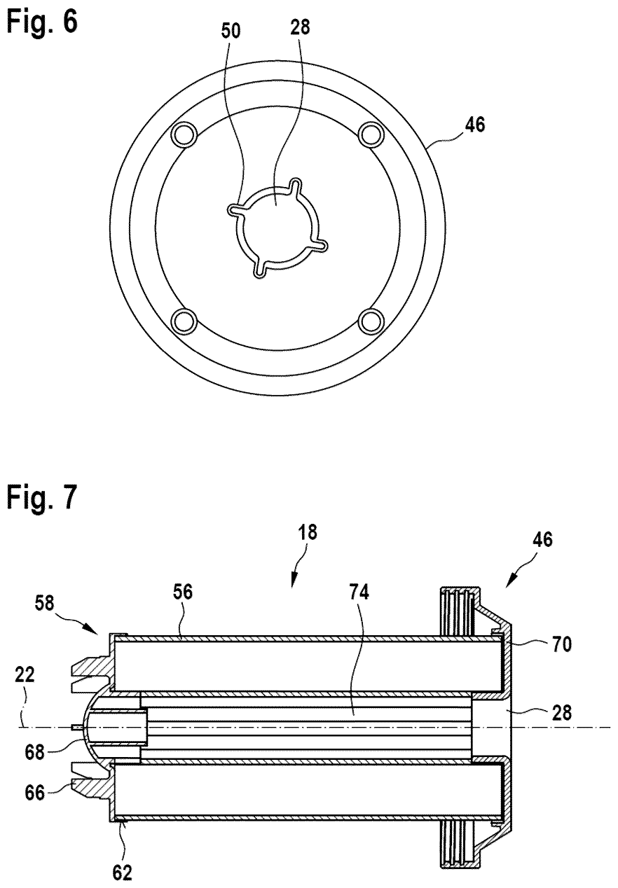

The particle collection device 10 comprises the collection unit 14 for collecting particles. The collection container 16 is configured as a dimensionally stable collection receptacle. The shape of the collection receptacle is substantially cylindrical. The collection container 16 is made of a plastic. The collection container 16 is open at both end sides. The collection container 16 is at least essentially formed by a cylindrical casing, in particular a hollow cylindrical casing. The collection unit 14 has a closure element 46 in the form of a closure cap. The closure element 46 is intended to close an opening of the collection container 16. The closure element 46 limits an outlet opening 28. The outlet opening 28 is arranged in the center of the closure element 46. Alternatively, however, it is also conceivable that the outlet opening 28 is arranged laterally offset to a center axis of the closure element 46 running parallel to a longitudinal axis 22. The outlet opening 28 has a shape deviating from a circular cross-section with at least one extension 50 delimiting a slit-like indentation of the outlet opening 28. In the present embodiment, the shape of the outlet opening has four such extensions 50. This embodiment of the shape of the outlet opening 28 with the extensions 50 makes it possible to insert the fluid guiding element 26 together with the impulse elements 24 extending over an outer surface 44 of the fluid guiding element 26 into the collection container 16, in particular without bending the impulse elements 24 (FIG. 6).

In the embodiment as a closure cap, the closure element 46 has a screw thread for screwing onto the collection container 16 of the collection unit 14. The closure element 46 is connected to the collection container 16 by means of a screw connection. Alternatively, however, it is also conceivable that the closure element is arranged on the collection container 16 by means of a plug connection, for example by means of a bayonet connection.

The particle collection device 10 further comprises a filter unit 18 for filtering particles from a fluid flow passing through the collection container 16. The filter unit 18 comprises a filter element 56 designed as a pleated filter, in particular as a lamella filter. The filter unit 18 has a hollow cylindrical geometry. However, it is also conceivable that the filter unit 18 has a cylindrical shape, a cuboid shape or the like. The filter element 18 has a circular cross-sectional shape when viewed in a plane extending perpendicular to the longitudinal axis 22. The outer edges of the folds of the pleated filter are arranged in a circular pattern with respect to the plane perpendicular to the longitudinal axis 22 of the filter unit 18. A filter medium of the filter unit 18 is formed from filter paper. Alternatively, however, the filter medium of the filter unit 18 may be formed from a nonwoven fabric, a synthetic material, textiles, glass fiber, a metal mesh, a combination of materials, or the like. The outside of the filter element 56 is exposed to particle-laden air, and particle-filtered air can flow out through a fluid flow channel 74 bounded by the filter element 56 parallel to the longitudinal axis 22 of the filter unit 18. The particle-filtered fluid flows out of the particle collection device 10 through the outlet opening 28.

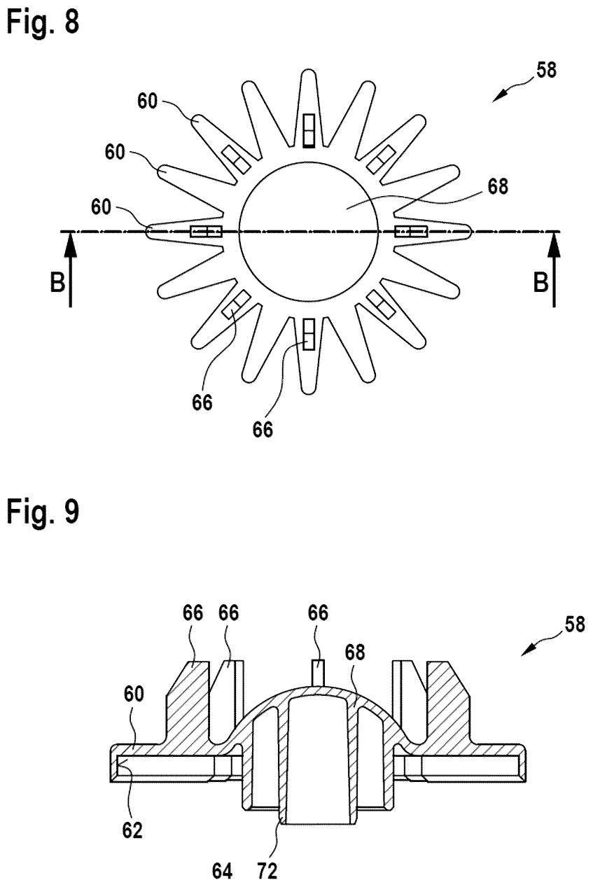

The filter unit 18 comprises a support element 58. The support element 58 is arranged by means of a material bond at an axial end of the filter element 56. The filter unit 18 comprises the support element 58. The support element 58 is arranged at an axial end of the filter element 56, in particular by means of a material bond. The support element 58 has a cross-sectional shape that is congruent with a cross-sectional shape of the filter element 56, which deviates from a circular cross-sectional shape. In the present embodiment of the filter unit 18 with a filter element 56 designed as a pleated filter, the support element 58 is star-shaped. As shown in detail in FIGS. 8 and 9, the support element 58 comprises at least two radial extensions 60, in the present case a plurality of radial extensions 60 designed as star prongs. For the sake of clarity, only some of the radial extensions 60 are provided with a reference numeral. The radial extensions 60 are spaced apart from each other along a circumferential direction with respect to their radial ends. In the present embodiment, the radial extensions 60 are arranged symmetrically about a center axis of the support element 58 extending coaxially with the longitudinal axis 22. Alternatively, however, it is also conceivable that the radial extensions 60 are not arranged symmetrically about a center axis of the support element 58 extending coaxially with the longitudinal axis 22. The radial extensions 60 define the cross-sectional shape of the filter element 56, which deviates from a circular cross-sectional shape. The radial extensions 60 each have a abutment surface 62 for bearing against the filter element 56 along a circumferential direction of the filter element 56. In the present embodiment, the abutment surfaces 62 limit the reception of an arrangement of filter star prongs of the filter element 56, which is designed as a pleated filter. The abutment surfaces 62 support the filter element 56 axially, radially, and circumferentially. This results in a positive locking between the abutment surfaces 62 and the axial end of the filter element 56 designed as a pleated filter in the radial direction of the filter element 56 and in the circumferential direction of the filter element 56. Alternatively, it is also conceivable that the abutment surfaces 62 of the support element 58 are completely surrounded by the filter element 56. In the present embodiment, the support element 58 is connected to the axial end of the filter element 58 by means of an adhesive bond. The support element 58 further comprises a cylindrical inner support wall 64 extending parallel to a center axis of the filter element 56. FIG. 9 shows the inner support wall 64 in a cross section through the support element 58 in FIG. 8, indicated by the dashed line and viewed in direction “B”. With respect to the center axis of the filter element 56, the inner support wall 64 is arranged closer to the center axis than the radial extensions 60 of the support element 58. The inner support wall 64 supports an axial end region of inner edges of folds of the filter element 56 designed as a pleated filter. In the present embodiment, the inner support wall 64 is formed by an annular wall element which extends symmetrically about the longitudinal axis 22 of the filter unit 18. The support element 58 further has at least one sword-like mounting centering extension 66. The mounting centering extension 66 is arranged on at least one of the radial extensions 60 on a side of the support element 58, in particular of the radial extension 60, facing away from the filter element 56. In the present embodiment, every second radial extension 60 has such a mounting centering extension 66. However, it is also conceivable that only every third or every fourth extension 60 or the like has such a mounting centering extension 66. A radial extension of the mounting centering extension 66 from the center of the axial extension of the mounting centering extension 66 starting from the support element 58 decreases linearly in the axial direction away from the support element 58 by 50% of the maximum radial extension of the mounting centering extension 66. Alternatively, the mounting centering extension 66 may have a different shape suitable for centering the filter unit 18 in the collection container 16 of the collection unit 14. The support element 58 further comprises a serrated flow optimization geometry 68. The serrated flow optimization geometry 68 is arranged on a side of the support element 58 facing away from the filter element 56. The serrated flow optimization geometry 68 is also arranged adjacent to the at least two radial extensions 60 of the support element 58. A center axis of the serrated flow optimization geometry 68 is arranged coaxially with the center axis of the support element 58. The serrated flow optimization geometry 68 is designed in the present case as a hollow spherical cap in the direction axially away from the support element 58. Alternatively, a differently designed geometry for the serrated flow optimization geometry 68 is conceivable. The support element 58 has a hollow plain cylindrical guide and/or bearing element 72 on a side of the support element 58 facing the filter element 56 for guiding and/or bearing the filter cleaning unit 20. The filter cleaning unit 20 can be inserted into the guide and/or bearing element 72 and is rotatably mounted in the guide and/or bearing element 72.

The particle collection device 10 further comprises a filter cleaning unit 20 for cleaning the filter element 56 of the filter unit 18. The filter cleaning unit 20 is arranged in the collection container 16. The filter cleaning unit 20 is rotatable about the longitudinal axis 22 relative to the collection container 16 and to the filter unit 18. However, it is also conceivable that the filter cleaning unit 20 is mounted so as to be rotatable about the longitudinal axis 22 relative to the collection container 16 or rotatable relative to the filter unit 18. The filter cleaning unit 20 has four impulse elements 24 which, when the filter cleaning unit 20 rotates, each transmit an impulse to individual folds of the filter element 56 of the filter unit 18. The filter cleaning unit 20 has a fluid guiding element 26 designed as a hollow shaft. The fluid guiding element 26 extends over the entire longitudinal extent of the filter unit 18. The fluid guiding element 26 discharges particle-filtered air on the clean air side of the filter unit 18 through the outlet opening 28 from the collection container 16.

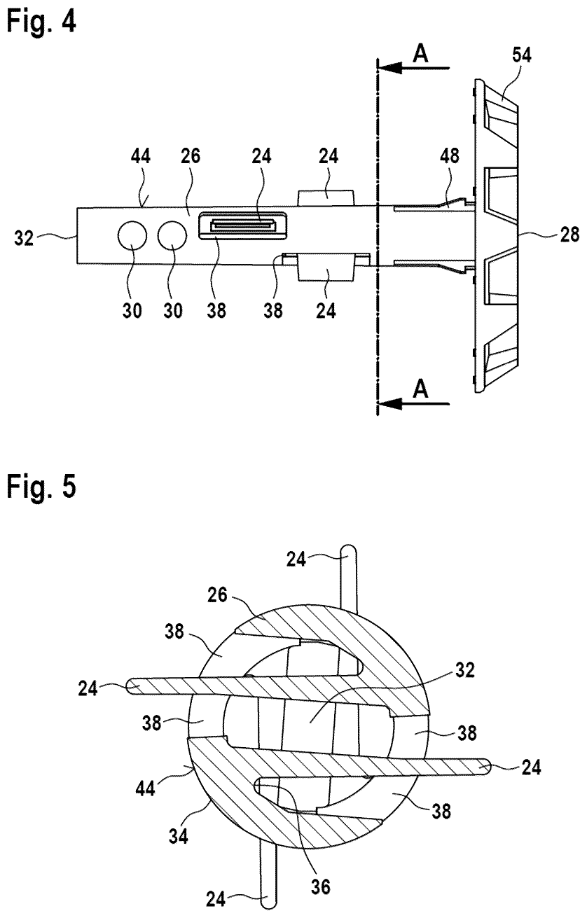

An actuating element 54 is arranged on the filter cleaning unit 20 to rotate the impulse element 24 together with the fluid guiding element 26 about the longitudinal axis 22 of the filter cleaning unit 20. The actuating element 54 is designed as a hand wheel. Alternatively, it is also possible for the actuating element 54 to be actuated by means of a servomotor. The collection container 16 has two securing units 52 to prevent the collection container 16 and the closure element 46 of the collection unit 14 from becoming detached, in particular accidentally, when the actuating element 54 is actuated. The securing units 52 are designed as axially elastic snap-in knobs which lock into a complementary locking geometry arranged on the closure element 46. The two snap-in knobs are arranged diametrically opposite each other on the collection container 16. However, it is also conceivable that the collection container has several snap-in knobs in a different arrangement. The securing units 52, which are designed as snap-in knobs, face the closure element 46 in the axial direction. However, it is conceivable that the securing units 52 are arranged on the outside of the collection container 16. The fluid guiding element 26 of the filter cleaning unit 20 has an inlet opening 30, in particular four inlet openings 30 (see also FIG. 4). The fluid flows through the inlet openings 30 into an inner channel 32 of the fluid guiding element 26. The inlet openings 30 are arranged in an outer wall 34 of the fluid guiding element 26, which runs at least substantially parallel to the longitudinal axis 22 of the filter cleaning unit 20. The inlet openings 30 for the fluid into the inner channel 32 of the fluid guiding element 26 are arranged in a region facing away from the outlet opening 28 in the outer wall 34 of the fluid guiding element 26, which runs essentially parallel to the longitudinal axis 22 of the filter cleaning unit 20. The region facing away extends from the end of the fluid guiding element 26 facing away from the outlet opening 28 over 20% of a maximum axial length of the fluid guiding element 26 extending parallel to the longitudinal axis 22. The inlet openings 30 are of the same design and are circular in shape. The diameter of the circular inlet openings 30 is at most 20% of an outer circumferential length of the fluid guiding element 26 perpendicular to the longitudinal axis 22. Two inlet openings 30 are arranged axially offset from one another in the outer wall 34 of the fluid guiding element 26. Furthermore, two inlet openings 30 are arranged diametrically opposite each other in the outer wall 34 of the fluid guiding element 26. Alternatively, it is conceivable that the inlet openings 30 have a shape other than a circular shape, for example an oval, rectangular or polygonal shape.

The fluid guiding element 26 has a locking element 48, which partially delimits an inner channel 32 of the fluid element 26, for locking with the closure element 46. The locking element 48 is designed as a spring locking element. The locking element 48, which is designed as a spring locking element, is designed as a rectangular section of the fluid guiding element 26 which is free-standing on three sides, has a main direction of extension parallel to the longitudinal axis 22 of the filter cleaning unit 20, and has a locking lug at its free-standing end. In the present embodiment, the fluid guiding element 26 has two such locking elements 48. The filter cleaning unit 20 has an impulse element 24. The impulse element 24 is trapezoidal in shape. Alternatively, another shape, for example a rectangular shape, of the impulse element 24 is conceivable. The impulse element 24 is arranged eccentrically offset relative to the longitudinal axis 22 of the filter cleaning unit 20 on the fluid guiding element 26.

Furthermore, the impulse element 24 is arranged on an inner wall 36 of the fluid guiding element 26 which bounds the inner channel 32 of the fluid guiding element 26. The impulse element 24 extends through a fluid guiding element recess 38 of the fluid guiding element 26, which is bounded by an outer wall 34 of the fluid guiding element 26. The impulse element 24 extends across the outer surface 44 of the fluid guiding element 26 along a direction perpendicular to the longitudinal axis 22 of the filter cleaning unit 20. The impulse element 24 has a main extension axis which forms an angle deviating from 90° with the outer surface 44 of the fluid guiding element 26 extending parallel to the longitudinal axis 22 of the filter cleaning unit 20.

The filter cleaning unit 20 has at least one further impulse element 24 offset along the longitudinal axis 22 relative to the impulse element 24. The further impulse element 24 is arranged on the inner wall 36 of the fluid guiding element 26, which delimits the inner channel 32 of the fluid guiding element 26. The further impulse element 24 extends through a further fluid guiding element recess 38 of the fluid guiding element 26, which is bounded by the outer wall 34 of the fluid guiding element 26. The further impulse element 24 extends further across the outer surface 44 of the fluid guiding element 26 along a direction perpendicular to the longitudinal axis 22 of the filter cleaning unit 20. The fluid guiding element recess 38 and the further fluid guiding element recess 38 are arranged offset by 90° relative to one another in a circumferential direction of the fluid guiding element 26. However, it is also conceivable that the fluid guiding element recess 38 and the further fluid guiding element recess 38 are arranged offset from one another by a smaller angle. In the present embodiment, the filter cleaning unit 20 comprises two impulse elements 24, which are each arranged on the inner wall 36 of the fluid guiding element 26 and each have a main extension axis, wherein the main extension axes of the impulse elements 24 extend parallel to each other in an unstressed state In particular, the illustrated embodiment has four such fluid guiding element recesses 38. In the embodiment shown, the impulse elements 24 are arranged on the inner wall 36 of the fluid guiding element 26, which delimits the inner channel 32 of the fluid guiding element 26. The impulse elements 24 each extend through one of the four fluid guiding element recesses 38 of the fluid guiding element 26. The impulse elements 24 extend over the outer surface 44 of the fluid guiding element 26. Two impulse elements 24 are arranged opposite each other on the inner wall 36 of the fluid guiding element 26. The present two pairs of oppositely arranged impulse elements 24 are arranged axially offset to one another along the fluid guiding element 26. Furthermore, the present two pairs of oppositely arranged impulse elements 24 are arranged radially rotated by 90° relative to each other. FIG. 4 and the cross-section through the fluid guiding element 26 shown in FIG. 5 (cf. FIG. 4, along the dashed line and looking in direction B) show the arrangement of the impulse elements 24 and the respective fluid guiding element recesses 38 of the present embodiment.

The collection unit 14 of the particle collection device 10 comprises a further closure element 78. The further closure element 78 is designed as a closure cap. The further closure element 78 is arranged on the side of the collection unit 14 facing the power tool 12. The further closure element 78 has an inlet opening 80. The inlet opening 80 allows particle-laden fluid to flow from the suction nozzle 76 of the power tool 12 into the collection container 16. The further closure element 78 is connected to the collection container 16 of the collection unit 14 by a screw connection. Alternatively, however, it is conceivable that the further closure element 78 is connected to the collection container 16 of the collection unit 14 by means of a bayonet connection, a clamping connection or the like.

The particle collection device 10 is detachably connected to the suction nozzle 76 of the power tool 12 via the further closure element 78. Alternatively, however, it is also conceivable that the particle collection device 10 is non-detachably connected to the suction nozzle 76 of the power tool 12. The particles removed from the workpiece by the machining tool 42 are guided by an air flow generated by a fan impeller for motor cooling (not shown here) from the workpiece through the suction nozzle 76 through the inlet opening 80 into the particle collection device 10. However, it is also conceivable that the power tool 12 has a combination fan wheel, which has fan blades for motor cooling and further blades for dust extraction. Alternatively, it is also possible for the removed particles to be fed into the particle collection device 10 by a fan of the power tool 12, which is designed separately for cooling the motor and by means of which an air flow can be generated for dust extraction. Other embodiments of the power tool 12 that appear useful to a person skilled in the art for generating an air flow for dust extraction are also conceivable.

The filter unit 18 also comprises a further support element 70. In the present embodiment, the closure element 46 forms the further support element 70. Alternatively, however, it is also conceivable that the further support element 70 is a separate element from the closure element 46. The further support element 70 limits the outlet opening 28 for discharging the particle-filtered fluid from the filter element 56. The further support element 70 is connected to the filter element 56 by a material bond at an end of the filter element 56 facing away from the support element 58. The filter element 56 is arranged on the further support element 70 in such a way that the extensions 50 are arranged within the fluid flow channel 74 bounded by the filter element 56.

The outer side of the filter element 56 facing radially away from the longitudinal axis 22 is flowed against with particle-laden air and particle-filtered air can flow out through the fluid flow channel 74 bounded by the filter element 56 parallel to the longitudinal axis 22 of the filter unit 18. The particle-filtered fluid flows out of the filter unit 18 through the outlet opening 28 (FIG. 7).

What is claimed is:

1. A particle collection device, comprising:
at least one collection unit configured to collect particles, the at least one collection unit including at least one collection container and at least one filter unit arranged in the at least one collection container, the at least one filter unit configured to filter particles from a fluid flowing through the at least one collection container;
at least one filter cleaning unit arranged on the at least one collection container, the at least one collection container defining a longitudinal axis about which the at least one filter cleaning unit is rotatably mounted relative to the at least one collection container and/or the at least one filter unit; and
at least one impulse element, of the at least one filter cleaning unit, configured to transmit an impulse to the at least one filter unit,
wherein the at least one filter cleaning unit comprises at least one fluid guiding element surrounded by the at least one filter unit,
wherein the at least one fluid guiding element extends over an entire longitudinal extent of the at least one filter unit, and
wherein the at least one fluid guiding element is configured to discharge the fluid through an outlet opening from the at least one collection container.

2. The particle collection device according to claim 1, wherein:
the at least one fluid guiding element comprises at least one inlet opening for the fluid into a cavity and/or into an inner channel of the at least one fluid guiding element, and
the at least one inlet opening is arranged in an outer wall of the at least one fluid guiding element extending parallel to the longitudinal axis.

3. The particle collection device according to claim 1, wherein the at least one impulse element is arranged eccentrically offset to the longitudinal axis on the at least one fluid guiding element.

4. The particle collection device according to claim 1, wherein:
the at least one fluid guiding element defines at least one inlet opening for the fluid into a cavity and/or into an inner channel of the at least one fluid guiding element, and
the cavity and/or the inner channel are arranged in a region facing away from the outlet opening in an outer wall of the at least one fluid guiding element extending parallel to the longitudinal axis.

5. The particle collection device according to claim 1, wherein:
the at least one impulse element is arranged on an inner wall of the at least one fluid guiding element and extends through a fluid guiding element recess of the at least one fluid guiding element,
the fluid guiding element recess is bounded by an outer wall of the at least one fluid guiding element, and
the at least one impulse element extends across an outer surface of the at least one fluid guiding element.

6. The particle collection device according to claim 5, wherein:
the at least one filter cleaning unit comprises at least one further impulse element offset along the longitudinal axis relative to the at least one impulse element,
the at least one further impulse element is arranged on an inner wall of the at least one fluid guiding element, and extends through a further fluid guiding element recess of the at least one fluid guiding element, and
the at least one further impulse element extends beyond an outer surface of the at least one fluid guiding element.

7. The particle collection device according to claim 6, wherein the fluid guiding element recess and the further fluid guiding element recess are offset from one another in a circumferential direction of the at least one fluid guiding element.

8. The particle collection device according to claim 1, wherein:
the at least one filter cleaning unit comprises at least two impulse elements each arranged on an inner wall of the at least one fluid guiding element and each defining a main extension axis, and
the main extension axes of the at least two impulse elements, in an unloaded state, extend parallel to each other or at an angle to each other.

9. The particle collection device according to claim 1, wherein the at least one impulse element defines a main extension axis forming an angle deviating from 90° with an outer surface of the at least one fluid guiding element.

10. The particle collection device according to claim 1, wherein:
the at least one collection unit has at least one closure element configured to delimit the outlet opening of the at least one collection container, and
the at least one fluid guiding element has at least one inner channel at least partially delimiting a locking element for locking with the at least one closure element.

11. The particle collection device according to claim 1, wherein:
the at least one collection unit has at least one closure element configured to delimit the outlet opening of the at least one collection container,
the outlet opening has a cross-sectional shape, deviating from a circular cross-section, and having at least one extension configured to delimit a slit-like indentation of the outlet opening,
the slit-like indentation of the outlet opening enables the at least one fluid guiding element to be inserted into the at least one collection container together with the at least one impulse element extending over an outer surface of the at least one fluid guiding element.

12. The particle collection device according to claim 1, further comprising:
at least one securing unit configured to prevent a release of a connection between the at least one collection container and a closure element of the at least one collection unit on which at least one actuating element of the at least one filter cleaning unit is arranged,
wherein the at least one actuating element is configured to counteract a rotation of the at least one impulse element together with the at least one fluid guiding element about the longitudinal axis.

13. A filter cleaning unit for a particle collection device according to claim 1.

14. A power tool, comprising:
at least one particle collection device according to claim 1.
